(19) United States
(12) Patent Application Publication
(10) Pub. No.: US 2006/0005689 A1
(43) Pub. Date: Jan. 12, 2006

(54) Pedal coupling device and bass drum

(76) Inventor: Fusamitsu Ito, Seto (JP)

Correspondence Address: OSTROLENK FABER GERB & SOFFEN, 1180 AVENUE OF THE AMERICAS, NEW YORK, NY, 100368403, US

(21) Appl. No.: 11/101,302

(22) Filed: Apr. 7, 2005

(30) Foreign Application Priority Data
Jul. 8, 2004 (JP) 2004-202113

(51) Int. Cl. G10D 13/02

(52) U.S. Cl. 84/422.1

(57) ABSTRACT

A pedal coupling device includes a body holding frame for holding the body of a bass drum, a base for placement on a supporting surface and coupled to a pedal device, and a bolt, which is a shaft for coupling the base to the body holding frame to be rotatable relative to each other. The base is rotatable between a coupling position at which the base is coupled to the pedal device and a storing position at which the base is located closer to the body. Rotating the base to the storing position when storing or carrying the bass drum enables compact storage of the pedal coupling device. Thus, the pedal coupling device is suitable for storing and carrying the bass drum.

### BACKGROUND OF THE INVENTION

The present invention relates to a coupling device for coupling a pedal device to a bass drum, and to a bass drum.

A bass drum includes a cylindrical body, a pair of heads, and a pair of hoops. The heads are disk-shaped and close the openings of the body. The hoops are annular and are fitted to the outer circumference of the ends of the body to tighten the heads to the body. The bass drum is placed on the floor such that the axis of the body extends along a supporting surface, i.e., the floor surface. A player plays the bass drum by hitting one of the heads with a beater.

U.S. Pat. No. 5,185,489 discloses a pedal device for a bass drum. The pedal device includes a foot pedal, which operates a beater during a performance, and a clamp. The pedal device is mounted to the bass drum by holding the lower portion of a hoop with the clamp from the player's side of the drum.

Vibration of the body caused by hitting the bass drum with the beater during a performance is easily transmitted to the floor via the clamp. Therefore, part of the vibration energy from the body is absorbed by the floor, and the vibration energy of the body is reduced. In this case, the original sound of the bass drum is not obtained.

Furthermore, since the hoop is directly held by the clamp, the hoop may be damaged. In addition, due to the striking or hitting force of the beater when hitting one of the heads with the beater, part of the hoop held by the clamp may be deformed or tightening of the head by the hoop may be loosened. Therefore, the tightening state of the head may be changed thereby changing the sound quality of the bass drum or the head may become untuned.

Also, since the clamp holds the annular hoop, the foot pedal of the pedal device mounted to the bass drum is easily inclined with respect to the floor surface. Furthermore, in a case where the bass drum is placed to incline toward the player, when the player depresses the foot pedal, part of the hoop held by the clamp receives downward force in a concentrated manner. Therefore, problems such as the reduction of vibration energy of the body, which spoils the original sound of the bass drum, and deformation of part of the hoop held by the clamp become more significant.

To solve these problems, U.S. Pat. No. 4,829,874 discloses a bass drum 100 provided with a pedal device without a hoop being held by a clamp (see FIG. 7). As shown in FIG. 7, the body 101 of the bass drum 100 is located on a floor surface 102a in a state where the body 101 is supported by a pedal holding device 102. The pedal holding device 102 is formed by a pair of rear legs 104 and a front leg 105, which support the body 101, and a support member 106, which integrally couples and supports the legs 104, 105. Vibration absorption bodies 107, 108 made of rubber material are provided at the distal ends of the rear legs 104 and the front leg 105. A pedal device 103 is coupled to the pedal holding device 102. The legs 104, 105 prevent the bass drum 100 from directly contacting the floor surface 102a, and the vibration absorption bodies 107, 108 suppress transmission of vibration of the body 101 to the floor. Therefore, the original sound of the bass drum 100 is supposed to be obtained with the pedal holding device 102.

However, the pedal holding device 102 has the following problems.

Since the pedal holding device 102 is formed by coupling the front leg 105 to the rear legs 104 with the support member 106, the structure is complicated. Furthermore, when storing or carrying the bass drum 100 after separating the pedal device 103 from the pedal holding device 102, the pedal holding device 102 projects sideways from the body 101 by a large amount. Therefore, it is difficult to store or carry the bass drum 100.

### SUMMARY OF THE INVENTION

Accordingly, it is an objective of the present invention to provide a pedal coupling device that does not spoil the original sound of a bass drum and is suitable for storing and carrying, and to provide a bass drum equipped with such a pedal coupling device.

To achieve the foregoing and other objectives and in accordance with the purpose of the present invention, a pedal coupling device for coupling a bass drum to a pedal device is provided. The bass drum has a body and a pair of heads attached to the body. The bass drum is for placement on a supporting surface, with the pedal device being for rotating a beater by depression of a foot pedal to hit one of the heads of the bass drum. The pedal coupling device includes a body, a base, and a shaft. The body holding frame holds the body of the bass drum. The base is placed on the supporting surface and coupled to the pedal device. The shaft couples the body holding frame to the base to be rotatable relative to each other.

The present invention also provides a bass drum for placement on a supporting surface. The bass drum includes a body, a pair of rear legs, a pair of heads attached to the body, a pedal device including a beater and a foot pedal that rotates the beater by depression of the foot pedal to hit one of the heads, and a pedal coupling device for coupling the pedal device to the bass drum. The bass drum further includes a pair of rear legs, which project from the bass drum and support the body. The pedal coupling device includes a body holding frame, a base, and a shaft. The body holding frame holds the body of the bass drum in cooperation with the pair of rear legs. The base is placed on the supporting and is coupled to the pedal device. The shaft couples the body holding frame to the base to be rotatable relative to each other.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a side view illustrating a bass drum according to a preferred embodiment of the present invention;

FIG. 2 is a perspective view illustrating the pedal coupling device;

FIG. 3 is an exploded perspective view illustrating the pedal coupling device;

FIG. 4 is a cross-sectional view taken along line 4-4 in FIG. 1;

FIG. 5 is a cross-sectional view taken along line 5-5 in FIG. 4;

FIG. 6 is a side view illustrating the pedal coupling device; and

FIG. 7 is a side view illustrating a conventional bass drum.

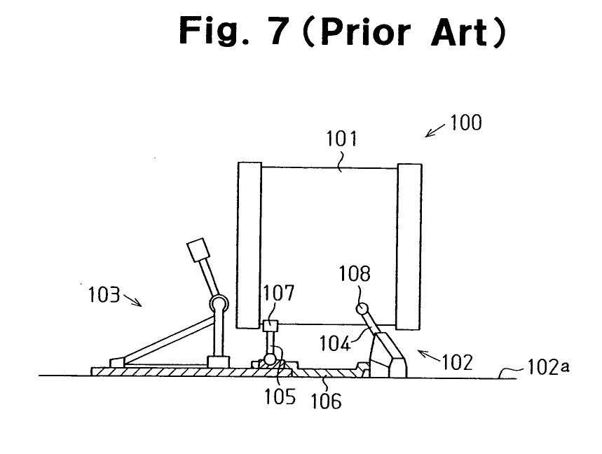

### DETAILED DESCRIPTION OF THE PREFERRED EMBODIMENTS

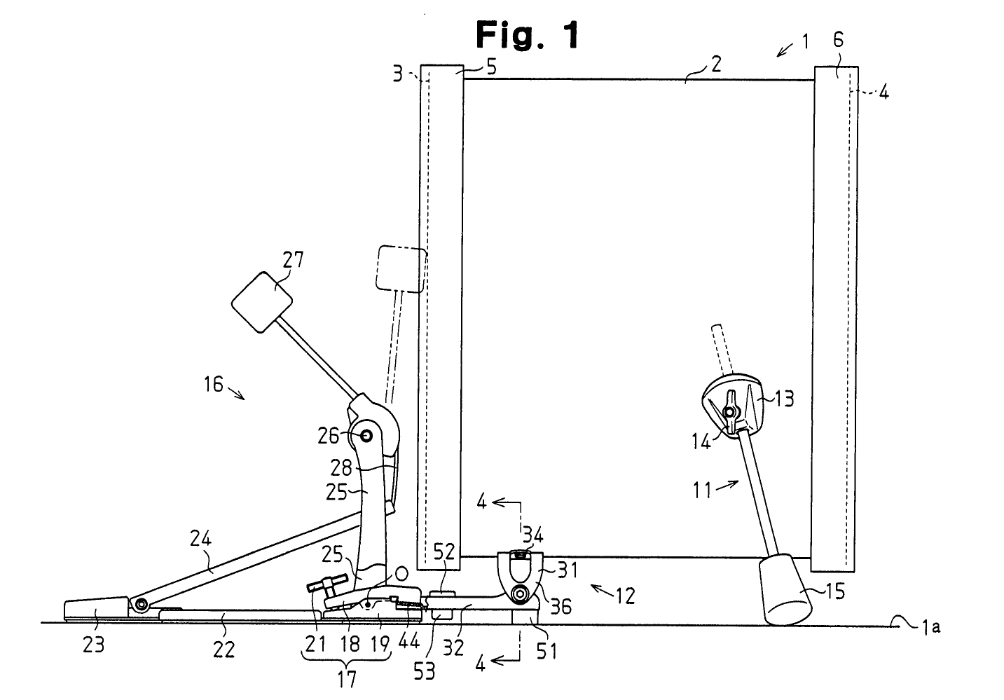

A pedal coupling device 12 and a bass drum 1 according to one embodiment of the present invention will now be described with reference to FIGS. 1-6.

As shown in FIG. 1, the bass drum 1 includes a cylindrical body 2. The bass drum 1 is placed on a supporting surface, which is a floor surface 1a in this embodiment, such that the axis of the body 2 extends along the floor surface 1a. The front opening of the body 2 is closed by a disk-like front head 3 and the rear opening of the body 2 is closed by a disk-like rear head 4. An annular front hoop 5 is fitted to the outer circumference of the front end of the body 2. The front hoop 5 tightens the front head 3 to the body 2. An annular rear hoop 6 is fitted to the outer circumference of the rear end of the body 2. The rear hoop 6 tightens the rear head 4 to the body 2.

The bass drum 1 is supported at three points by a pair of rear legs 11 located at the rear portion of the body 2 and the pedal coupling device 12 located below the front portion of the body 2 in a state where the bass drum 1 is apart from the floor surface 1a. The proximal end of each rear leg 11 is inserted in the body 2 via a bracket 13 attached to the body 2. Each rear leg 11 is secured to the body 2 by fastening a fastening bolt 14 screwed to the bracket 13. The setting posture of the bass drum 1 is adjustable by changing the length of the rear legs 11 to be inserted in the body 2. That is, the inclination angle of the body 2 with respect to the floor surface 1a is variable by changing the length of the rear legs 11 to be inserted in the body 2. A rubber cushion 15 is attached to the distal end of each rear leg 11.

A pedal device 16 is located in front of the bass drum 1. The pedal device 16 includes a clamp 17, which is formed of a holding member 18, a columnar support base 19, and a fastening bolt 21 screwed to the holding member 18. The holding member 18 is located on the columnar support base 19. The holding member 18 is vertically rotatable about an axis O, which is substantially parallel to the floor surface 1a. When the fastening bolt 21 is tightened, the rear end of the holding member 18 rotates downward. The clamp 17 sandwiches the upper and lower surfaces of a joint portion 44 located at the front end of the pedal coupling device 12 with the holding member 18 that is rotated downward and the columnar support base 19. The tightening state of the pedal coupling device 12 is adjustable by changing the tightening amount of the fastening bolt 21.

A base plate 22 extends from the front end of the clamp 17. A heel portion 23 is attached to the front end of the base plate 22. Two columnar supports 25 are located on the columnar support base 19. A horizontally extending rotary shaft 26 is supported between the upper portions of the columnar supports 25. The rotary shaft 26 rotatably supports a beater 27. The front end of a foot pedal 24 is attached to the heel portion 23. The foot pedal 24 is rotatable about its proximal end. The beater 27 is coupled to the distal end of the foot pedal 24 via a chain member 28. When a player depresses the foot pedal 24, the beater 27 rotates about the rotary shaft 26 and hits the front head 3 as shown by the chain double-dashed line in FIG. 1. The bass drum 1 is played in this manner.

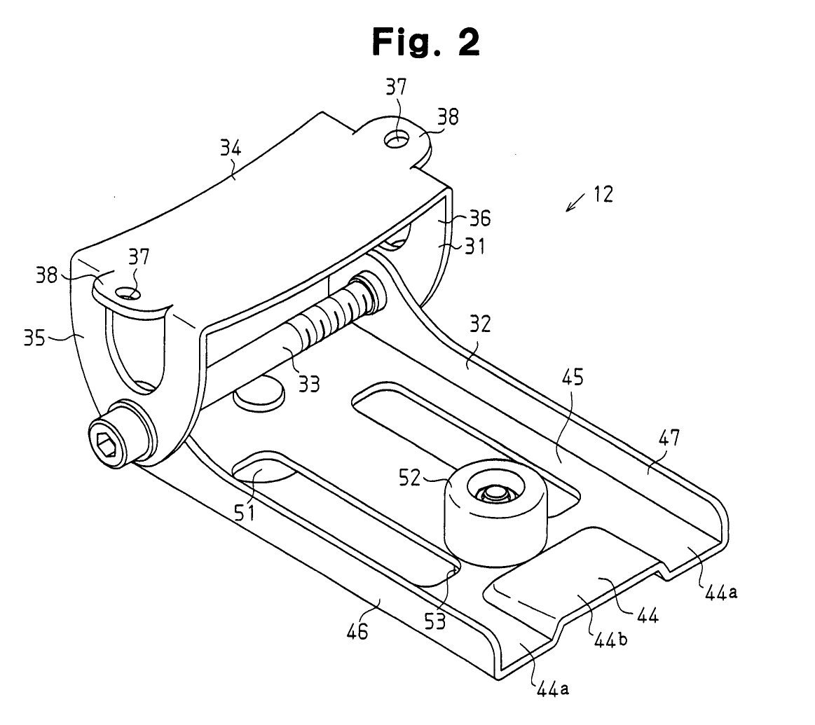

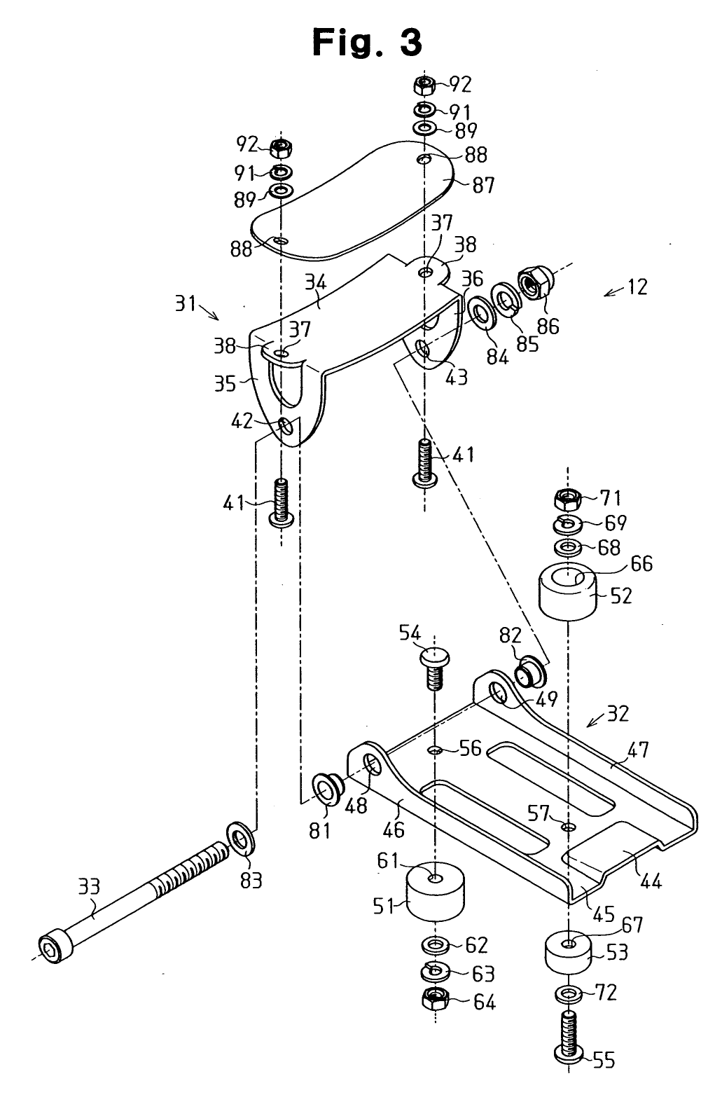

As shown in FIGS. 2 and 3, the pedal coupling device 12 is formed of a body holding frame 31, which holds the body 2 of the bass drum 1, a base 32, which is located on the floor surface 1a and is coupled to the pedal device 16, and a shaft, which is a bolt 33 in this embodiment. The bolt 33 couples the base 32 and the body holding frame 31 to be rotatable relative to each other. The body holding frame 31 and the base 32 are made of sheet steel.

The body holding frame 31 is formed into an inverted U-shape and includes a rectangular plate-like mounting portion 34 and a pair of coupling portions 35, 36, which extend downward from both longitudinal ends of the mounting portion 34. A pair of tabs 38 project from the longitudinal ends of the mounting portion 34 extending along the longitudinal direction of the mounting portion 34. The mounting portion 34 and the tabs 38 curve in accordance with the outer circumferential surface of the body 2. A hole 37 is formed in each tab 38. A bolt 41 is inserted into each hole 37 from below when attaching the pedal coupling device 12 to the body 2. The coupling portions 35, 36 are formed into a semi-elliptical annular shape. At the distal end of each coupling portion 35, 36, a shaft bore 42, 43 into which the bolt 33 is inserted is respectively formed. The mounting portion 34 is separate from the bolt 33.

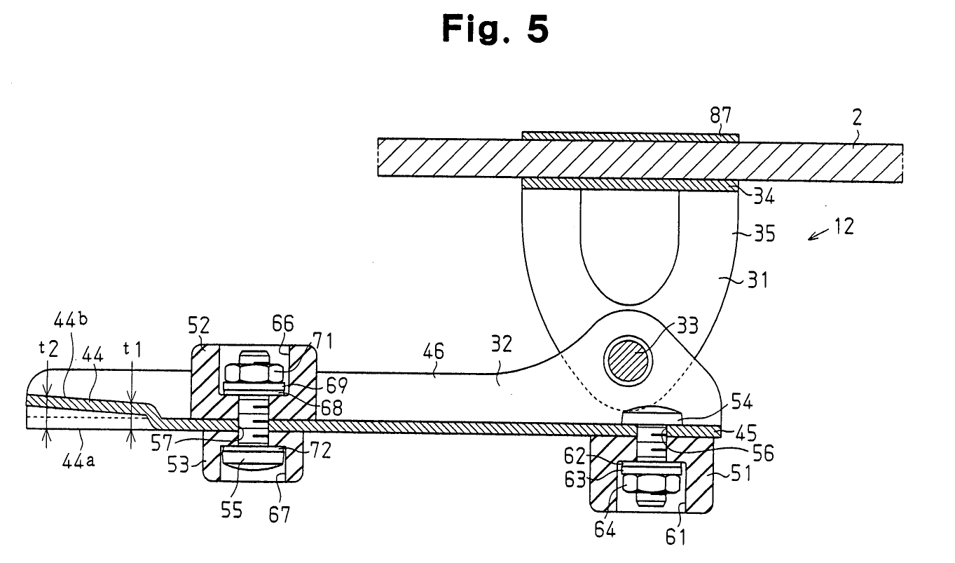

The base 32 includes a rectangular bottom surface portion 45, which extends along the front and rear direction, and a pair of side surface portions 46, 47, which extend upward from both lateral ends of the bottom surface portion 45. The joint portion 44, which is sandwiched by the clamp 17 of the pedal device 16, is formed at the front end of the bottom surface portion 45. The joint portion 44 is formed by a pair of flat portions 44a located at the lateral ends of the bottom surface portion 45 and an inclined portion 44b located between the flat portions 44a. As shown in FIG. 5, the inclined portion 44b is formed by causing the bottom surface portion 45 to slightly project upward by pressing. The inclined portion 44b is inclined such that the front end of the inclined portion 44b is the highest. Therefore, the joint portion 44 becomes thicker toward the front end, that is, toward the clamp 17. The thickness of the joint portion 44 refers to the distance between the upper surface of the inclined portion 44b and the lower surface of the flat portion 44a. More specifically, the distance t1 between the upper surface of the rear end of the inclined portion 44b and the lower surface of the rear end of the flat portion 44a is shorter than the distance t2 between the upper surface of the front end of the inclined portion 44b and the lower surface of the front end of the flat portion 44a. As shown in FIG. 1, the joint portion 44 is entirely sandwiched by the clamp 17.

As shown in FIG. 3, at the rear end of each side surface portion 46, 47, a shaft bore 48, 49 into which the bolt 33 is inserted is respectively formed. A bore 56 is formed at the rear end of the bottom surface portion 45 and a bore 57 is formed at the front end of the bottom surface portion 45.

A front leg 51 is located on the lower surface of the bottom surface portion 45 corresponding to the bore 56. The front leg 51 contacts the floor surface 1a to support the front portion of the bass drum 1 with the floor surface 1a. The front leg 51 is formed into a columnar shape with rubber material. A securing bore 61 having a circular cross-section is formed at the center of the front leg 51 as shown in FIG. 5. The securing bore 61 extends in the vertical direction through the front leg 51. The inner diameter of the upper portion of the securing bore 61 is set smaller than the inner diameter of the lower portion of the securing bore 61. A flat washer 62, a spring washer 63, and a hexagonal nut 64 are sequentially inserted in the securing bore 61 from below. A bolt 54 is inserted in the securing bore 61 via the bore 56 from above the bottom surface portion 45. The bolt 54 is screwed to the hexagonal nut 64 via the washers 62, 63 so that the front leg 51 is secured to the bottom surface portion 45.

Two shock absorbing members 52, 53 are located at a position of the bottom surface portion 45 corresponding to the bore 57 to sandwich the upper and lower surfaces of the bottom surface portion 45. The shock absorbing member 52 is formed of rubber material into a columnar shape and is located on the upper surface of the bottom surface portion 45. A securing bore 66 having a circular cross-section is formed at the center of the shock absorbing member 52. The securing bore 66 extends in the vertical direction through the shock absorbing member 52. The inner diameter of the upper portion of the securing bore 66 is set greater than the inner diameter of the lower portion of the securing bore 66. A flat washer 68, a spring washer 69, and a hexagonal nut 71 are sequentially inserted in the securing bore 66 from above.

The shock absorbing member 53 is formed of rubber material into a columnar shape and is located on the lower surface of the bottom surface portion 45. A securing bore 67 having a circular cross-section is formed at the center of the shock absorbing member 53. The securing bore 67 extends in the vertical direction through the shock absorbing member 53. The inner diameter of the upper portion of the securing bore 67 is set smaller than the inner diameter of the lower portion of the securing bore 67. A flat washer 72 is inserted in the securing bore 67 from below. A bolt 55 is inserted in the securing bore 66 via the securing bore 67 and the bore 57 from below the shock absorbing member 53. The bolt 55 is screwed to the hexagonal nut 71 via the washers 68, 69, 72 so that the shock absorbing members 52, 53 are secured to the bottom surface portion 45.

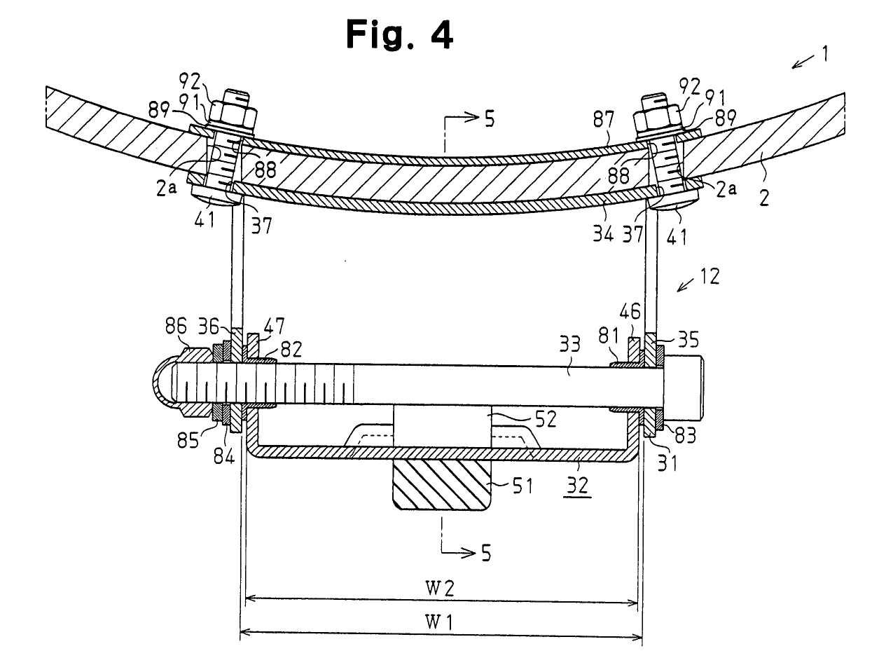

As shown in FIG. 4, the coupling portions 35, 36 are arranged to cover the side surface portions 46, 47 from the outside. Sleeves 81, 82 are located between the coupling portions 35, 36 and the side surface portions 46, 47, respectively. As shown in FIG. 3, a flat washer 83 is located outward of the coupling portion 35. On the other hand, a flat washer 84, a spring washer 85, and a hexagonal cap nut 86 are located outward of the coupling portion 36 in this order from the coupling portion 36. After the bolt 33 is inserted in the shaft bores 42, 48 via the washer 83, the bolt 33 is inserted in the shaft bores 49, 43 and further screwed to the hexagonal cap nut 86 via the washers 84, 85. Accordingly, the body holding frame 31 is coupled to the base 32.

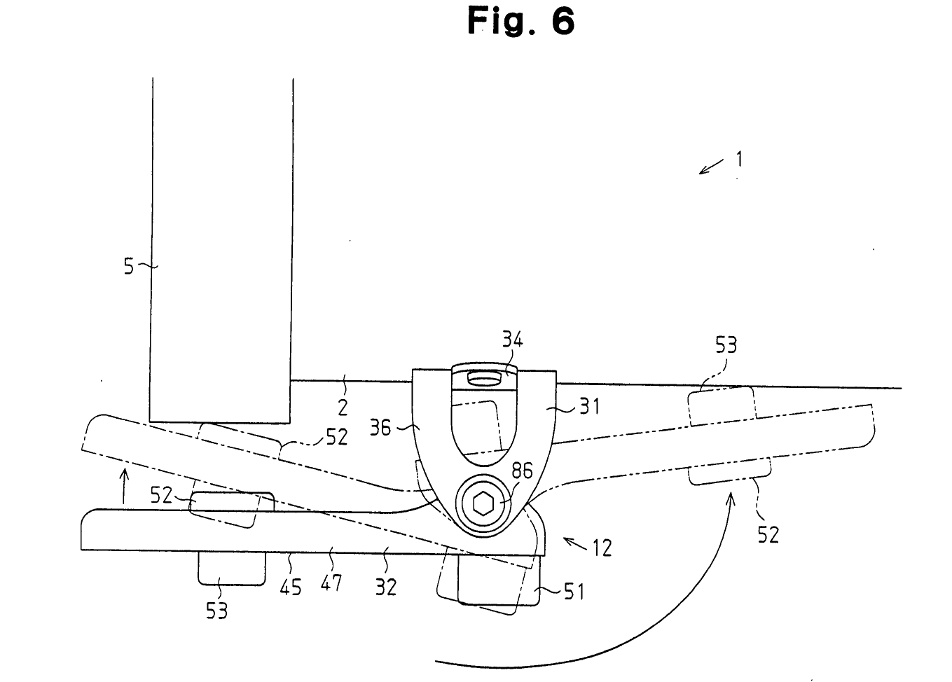

As shown in FIG. 4, the internal width W1 of the body holding frame 31 is wider than the external width W2 of the base 32 by the thickness of the sleeves 81, 82. The body holding frame 31 is coupled to the base 32 with moderate tightening. The body holding frame 31 and the base 32 are rotatable relative to each other while being supported by the bolt 33. Since the base 32 rotates with moderate resistance due to the moderate tightening, the base 32 stops at any angular position and can be maintained at that position. Furthermore, in a state where the body holding frame 31 is secured to the drum 1, the base 32 is rotatable among a coupling position at which the base 32 is coupled to the pedal device 16 as shown by a solid line in FIG. 6, a storing position at which the shock absorbing member 53 abuts against the body 2 as shown by a chain double-dashed line in FIG. 6, and a position at which the shock absorbing member 52 abuts against the front hoop 5 as shown by a dashed line in FIG. 6.

As shown in FIGS. 3 and 4, a securing plate 87 is located at a position in the body 2 of the bass drum 1 corresponding to the mounting portion 34. The securing plate 87 is formed into a rectangular shape with rounded corners. The securing plate 87 curves in accordance with the inner circumferential surface of the body 2. Holes 88 are formed at portions of the securing plate 87 corresponding to the holes 37 of the tabs 38. Holes 2a are formed at portions of the body 2 corresponding to the holes 37, 88. A pair of flat washers 89, a pair of spring washers 91, and a pair of hexagonal nuts 92 are sequentially provided on the securing plate 87 corresponding to the pair of holes 88. Bolts 41, which are inserted in the holes 37 from below the tabs 38, are inserted in the holes 2a, 88 and are further screwed to the hexagonal nuts 92 via the flat washers 89 and the spring washers 91, respectively. Accordingly, the pedal coupling device 12 is secured to the body 2.

The pedal device 16 is detachable from the pedal coupling device 12 by releasing the joint portion 44 from the clamp 17 by loosening the fastening bolt 21 of the clamp 17. When storing or carrying the bass drum 1, after separating the pedal device 16 from the pedal coupling device 12, the base 32 is rotated rearward from the coupling position to the storing position. Further, the two rear legs 11 are detached from the body 2 by loosening the fastening bolts 14. At this time, the shock absorbing member 53 abuts against the body 2, thereby preventing the base 32 from contacting and damaging the body 2.

Furthermore, if the base 32 is rotated forward to the position shown by the dashed line in FIG. 6 when the pedal device 16 is separated from the pedal coupling device 12, the shock absorbing member 52 of the base 32 abuts against the front hoop 5. Therefore, the base 32 is prevented from contacting and damaging the front hoop 5. In the same manner, when the rear portion of the bass drum 1 is lifted while the bass drum 1 is supported on the floor surface 1a, the shock absorbing member 52 of the base 32 abuts against the front hoop 5, thereby preventing the base 32 from contacting and damaging the front hoop 5.

The preferred embodiment provides the following advantages.

(1) The body holding frame 31 and the base 32 are coupled to rotate relative to each other with the bolt 33. Therefore, the body 2, to which the pedal coupling device 12 is attached, is rotatable about the bolt 33. The rear portion of the bass drum 1 is slightly lifted so that the bass drum 1 is tilted forward, that is, toward the player to prevent the bass drum 1 from moving rearward due to hitting force of the beater 27. According to the pedal coupling device 12 of the preferred embodiment, the inclination angle of the bass drum 1 is easily changed by varying the length of the rear legs 11 to be inserted in the body 2. Furthermore, the beating spot of the beater 27 on the front head 3 and the stroke of the beater 27 are easily adjusted in accordance with the inclination angle of the bass drum 1.

(2) In a state where the body holding frame 31 is secured to the drum 1, the base 32 is rotatable between the coupling position and the storing position. Furthermore, the base 32 that is rotated to the storing position is maintained at the storing position with the moderate tightening. Rotating the base 32 to the storing position when storing or carrying the bass drum 1 enables compact storage of the pedal coupling device 12. Thus, the pedal coupling device 12 is suitable for storing and carrying the bass drum 1.

(3) The rubber cushions 15 are attached to the distal ends of the rear legs 11 and the front legs 51 are made of rubber material. This prevents part of vibration of the body 2 from being transmitted to the floor during a performance and vibration energy of the body 2 from being reduced. As a result, the original sound of the bass drum 1 is easily obtained.

(4) The pedal coupling device 12 is secured to the body 2 without clamping the hoop 5 and is coupled to the pedal device 16. Therefore, vibration of the body 2 is prevented from being transmitted to the floor via the clamp 17, and the hoop 5 is prevented from being damaged by clamping. Furthermore, the hoop 5 is prevented from being deformed by the hitting force of the beater 27. This prevents the sound of the bass drum 1 from being changed or the head 3 from becoming untuned due to deformation of the hoop 5.

In addition to preventing the hoop 5 from being deformed even when there is repeated hitting with the beater 27, the pedal device 16 is stably mounted to the bass drum 1 as compared to the conventional pedal device, which is mounted to the bass drum 1 by clamping the hoop 5.

(5) The joint portion 44 becomes thicker toward the clamp 17 and is entirely sandwiched by the clamp 17. Therefore, when the bass drum 1 is pressed rearward by the hitting force of the beater 27, the front end of the joint portion 44 engages with the clamp 17. Thus, as compared to a case where the front end and the rear end are formed to have the same thickness, the joint portion 44 prevents the bass drum 1 from moving rearward due to the hitting force of the beater 27. This prevents the pedal coupling device 12 from being separated from the pedal device 16 during a performance. Furthermore, the clamp 17 is prevented from being disengaged from the joint portion 44 in an unexpected manner without further providing a structure for preventing the clamp 17 from being disengaged from the joint portion 44, for example, without providing antislip asperities on the surface of the joint portion 44.

(6) The inclined portion 44b of the joint portion 44 is formed by pressing the bottom surface portion 45. Therefore, another member does not need to be added to the bottom surface portion 45 to form the inclined portion 44b. This facilitates the formation of the inclined portion 44b.

(7) The body holding frame 31 is coupled to the base 32 with the bolt 33 and the hexagonal cap nut 86. Therefore, according to the pedal coupling device 12, the body holding frame 31 is easily exchanged with another body holding frame having a different distance between the mounting portion 34 and the shaft bores 42, 43 by releasing the bolt 33 from the hexagonal cap nut 86. Thus, the lift amount of the bass drum 1, that is, the distance between the body 2 and the floor surface 1a is easily changed.

(8) The shock absorbing members 52, 53 are secured to the bottom surface portion 45 of the base 32. Therefore, when rotating the base 32, the hoop 5 and the body 2 are prevented from being damaged by the base 32 in an unexpected manner.

The above embodiment may be modified as follows.

The bolt 33 may be omitted. Instead, a shaft may be formed by a pair of engaging projections provided on the inner surfaces of the coupling portions 35, 36 and a pair of engaging recesses provided on the outer surfaces of the side surface portions 46, 47. The engaging recesses are then engaged with the engaging projections. In this case, washers may be attached to the engaging projections before the engaging projections are engaged with the engaging recesses as required.

The body holding frame 31 and the base 32 may be coupled with a pair of bolts. That is, a bolt may be inserted in the shaft bores 42, 48 and another bolt may be inserted in the shaft bores 43, 49.

The shape of the mounting portion 34 may be changed to, for example, a disk-like shape. The mounting portion 34 may also be divided into two at the center. Furthermore, an elastic body such as a rubber sheet may be provided on the upper surface of the mounting portion 34. Furthermore, the mounting portion 34 may be omitted. In this case, the tabs 38 project from the coupling portions 35, 36 and function also as the mounting portion 34. These changes are made taking into consideration the necessity for the body holding frame 31 to have the strength to hold the body 2 and the resonance of the body 2 and the body holding frame 31.

The shape of the coupling portions 35, 36 may be a semicircle. The distance between the mounting portion 34 and the shaft bores 42, 43 may be changed as required.

The distance between the mounting portion 34 and the bolt 33 may be designed to be variable using the coupling portions 35, 36. For example, each coupling portion 35, 36 may be formed by two overlapping plate members. A slit is then formed in each plate member to extend in the vertical direction. A bolt is inserted through the slits of the overlapping plate members and a nut is screwed to the bolt. In this case, the distance between the mounting portion 34 and the bolt 33 is changed by changing the position of the bolt to be inserted in the slits.

The shock absorbing member 53 may be omitted. In this case, the securing position of the front leg 51 on the bottom surface portion 45 may be changed such that the front leg 51 functions also as the shock absorbing member 53.

The height of the front leg 51 and the shock absorbing members 52, 53 may be changed. The front leg 51 and the shock absorbing members 52, 53 may be formed of elastic material other than rubber material.

Antislip asperities may be formed on the surface of the joint portion 44. In this case, the clamp 17 is further reliably prevented from being disengaged from the joint portion 44 in an unexpected manner.

Therefore, the present examples and embodiments are to be considered as illustrative and not restrictive and the invention is not to be limited to the details given herein, but may be modified within the scope and equivalence of the appended claims.

1. A pedal coupling device for coupling a bass drum to a pedal device, wherein the bass drum has a body and a pair of heads attached to the body, the bass drum being for placement on a supporting surface, with the pedal device being for rotating a beater by depression of a foot pedal to hit one of the heads of the bass drum, the pedal coupling device comprising:
a body holding frame for holding the body of the bass drum;
a base for placement on the supporting surface, the base being coupled to the pedal device; and
a shaft for coupling the body holding frame to the base to be rotatable relative to each other.

2. The pedal coupling device according to claim 1, wherein, while the bass drum is held by the body holding frame, the base is rotatable between a coupling position at which the base is coupled to the pedal device and a storing position at which the base is located closer to the body of the bass drum.

3. The pedal coupling device according to claim 2, further comprising:
a shock absorbing member located on a lower surface of the base, wherein, when the base is rotated to the storing position, the shock absorbing member abuts against the body.

4. The pedal coupling device according to claim 1, wherein the body holding frame includes:
a mounting portion on which the body is mounted; and
a coupling portion for rotatably coupling the mounting portion to the shaft.

5. The pedal coupling device according to claim 1, further comprising:
a front leg located on a lower surface of the base, wherein the front leg is formed of an elastic member and is for abutting against the supporting surface.

6. The pedal coupling device according to claim 1, wherein the pedal device includes a clamp, and
wherein the base includes a joint portion, which is sandwiched by the clamp and becomes thicker toward the clamp.

7. A bass drum for placement on a supporting surface, the bass drum comprising a body, a pair of heads attached to the body, a pedal device including a beater and a foot pedal that rotates the beater by depression of the foot pedal to hit one of the heads, and a pedal coupling device for coupling the pedal device to the bass drum,
wherein the bass drum further includes a pair of rear legs, which project from the bass drum and support the body; and
wherein the pedal coupling device includes:
a body holding frame for holding the body of the bass drum in cooperation with the pair of rear legs;
a base for placement on the supporting surface, the base being coupled to the pedal device; and
a shaft for coupling the body holding frame to the base to be rotatable relative to each other.

8. The bass drum according to claim 7, wherein, while the bass drum is held by the body holding frame, the base is rotatable between a coupling position at which the base is coupled to the pedal device and a storing position at which the base is located closer to the body of the bass drum.

9. The bass drum according to claim 8, wherein the pedal coupling device further includes:
a shock absorbing member located on a lower surface of the base, wherein, when the base is rotated to the storing position, the shock absorbing member abuts against the body.

10. The bass drum according to claim 7, wherein the body holding frame includes:
a mounting portion on which the body is mounted; and
a coupling portion for rotatably coupling the mounting portion to the shaft.

11. The bass drum according to claim 7, wherein the pedal coupling device further includes:
a front leg located on a lower surface of the base, wherein the front leg is formed of an elastic member for abutting against the supporting surface.

12. The bass drum according to claim 7, wherein the pedal device includes a clamp, wherein the base includes a joint portion, which is sandwiched by the clamp and becomes thicker toward the clamp.
